(19) United States
(12) Patent Application Publication
(10) Pub. No.: US 2009/0169793 A1
(43) Pub. Date: Jul. 2, 2009

(54) DOUBLE-SIDED ADHESIVE TAPE

(75) Inventors: Oral Aydin, Mannheim (DE); Andree Dragon, Speyer (DE); Stefan Kirsch, Nieder-Olm (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/297,270

(22) PCT Filed: May 2, 2007
(86) PCT No.: PCT/EP2007/054251

§ 371 Date: Oct. 15, 2008

(30) Foreign Application Priority Data
May 11, 2006 (EP) 06113804.6

(51) Int. Cl. B32B 27/36; B32B 27/06; B05D 5/10

(52) U.S. Cl. 428/41.3; 428/220; 427/208.8

(57) ABSTRACT

Multilayer laminate comprising at least two pressure-sensitive adhesive layers and a carrier layer located between the pressure-sensitive adhesive layers and comprising a synthetic polymer.

### DESCRIPTION

Pressure-sensitive adhesives (PSAs) are used for producing self-adhesive articles, such as labels, adhesive tapes or self-adhesive sheets. The self-adhesive articles are generally composed of two or more layers, in particular a backing or carrier layer, a PSA layer, and a detachable antistick layer which protects the PSA layer prior to its use. For specific applications there are also double-sided adhesive tapes available. These adhesive tapes are generally composed of a stable carrier, such as a woven textile fabric, for example, which is coated on either side with a PSA.

In the production of the double-sided adhesive tapes one side of the carrier is coated first and then in a second step the second side is coated.

A disadvantage associated with the existing double-sided adhesive tapes, therefore, is a complicated production method. The desire is for a simpler production method. The desire is also for the capacity to use other carrier materials, not least thinner and lighter carriers.

It was an object of the present invention, therefore, to provide a simpler method of producing double-sided adhesive tapes. A further object was to provide improved double-sided adhesive tapes having a new layer structure.

Found accordingly have been the multilayer laminate defined at the outset, the use of the laminate, and a method of producing it.

The pressure-sensitive adhesive layers

The laminate of the invention comprises at least two pressure-sensitive adhesive (PSA) layers, i.e., the two layers are each composed of a PSA.

A PSA is an adhesive which is permanently tacky at room temperature (21° C.).

The statements below apply to the PSA of both layers, unless specific reference is made to one of the layers.

The PSA comprises as its binder preferably a synthetic polymer (referred to below as PSA polymer).

Suitable PSA polymers include free-radically polymerized polymers, polyesters or polyadducts. The polymer in question is in particular a polymer obtainable by free-radical addition polymerization, more preferably a polymer obtainable by emulsion polymerization. With very particular preference the PSA polymer is an emulsion polymer.

In particular the PSA polymer is synthesized from free-radically polymerizable compounds (monomers). It is preferably composed of at least 40%, more preferably at least 60%, and very preferably at least 80%, by weight of what are called principal monomers.

The principal monomers are selected from C1-C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and 1 or 2 double bonds, or mixtures of these monomers.

Examples include (meth)acrylic acid alkyl esters with a C1-C10 alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Examples of vinyl esters of carboxylic acids with 1 to 20 C atoms are vinyl laurate, vinyl stearate, vinyl propionate, Versatic acid vinyl esters, and vinyl acetate.

Suitable vinylaromatic compounds include vinyltoluene a- and p-methylstyrene, a-butyl-styrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether and vinyl isobutyl ether. Preference is given to vinyl ethers of alcohols comprising 1 to 4 C atoms.

As hydrocarbons having 2 to 8 C atoms and one or two olefinic double bonds mention may be made of butadiene, isoprene and chloroprene, ethylene or propylene. Polymers or copolymers obtained from butadiene or isoprene can also be hydrogenated subsequently.

Preferred principal monomers are vinyl esters, preferably vinyl acetate, especially in combination with ethylene (vinyl acetate/ethylene copolymers for short), butadiene, especially in combination with styrene (butadiene/styrene copolymers for short), and the C1 to C10 alkyl acrylates and methacrylates, especially C1 to C8 alkyl acrylates and methacrylates (polyacrylates for short), particular preference being given in each case to polyacrylates.

Very particular preference is given to methyl acrylate, ethyl acrylate, n-butyl acrylate, n-hexyl acrylate, octyl acrylate, and 2-ethylhexyl acrylate, and to mixtures of these monomers.

Besides the principal monomers the PSA polymer may comprise further monomers, examples being monomers with carboxylic acid, sulfonic acid or phosphonic acid groups. Carboxylic acid groups are preferred. Examples that may be mentioned include acrylic acid, methacrylic acid, itaconic acid, maleic acid and fumaric acid.

Further monomers are, for example, monomers comprising hydroxyl groups as well, especially C1-C10 hydroxyalkyl (meth)acrylates, (meth)acrylamide, and monomers comprising ureido groups, such as ureido (meth)acrylates.

As further monomers mention may additionally be made of phenyloxyethyl glycol mono(meth)acrylate, glydidyl acrylate, glycidyl methacrylate, and amino(meth)acrylates such as 2-aminoethyl (meth)acrylate.

Monomers which besides the double bond carry further functional groups, isocyanate-, amino-, hydroxy-, amide- or glycidyl-, for example, may have the effect, for example, of enhancing the adhesion to substrates. Also particularly suitable are cyclic lactams such as N-vinylpyrrolidone or N-vinylcaprolactam.

Also suitable are PSAs whose properties can be adjusted by photochemical crosslinking, such as by irradiation with electron beams or UV light, for example (acResin® from BASF).

The glass transition temperature (Tg) of the PSA polymer is preferably −65 to +10° C., more preferably −65 to 0° C., very preferably −65 to −10° C., or −65 to −20° C.; in one very particularly preferred embodiment the glass transition temperature is −55 to −30° C., or −50 to −40° C.

The glass transition temperature of the polymer can be determined by standard techniques such as differential thermoanalysis or differential scanning calorimetry (see, for example, ASTM 3418/82, midpoint temperature).

The PSA may be composed of the binder alone (PSA polymer) or else may comprise further additives. Suitable examples include what are called tackifying resins (or tackifiers).

Tackifiers are, for example, natural resins, such as rosins and their disproportionation or isomerization, polymerization, dimerization and/or hydrogenation derivatives. They may be present in their salt form (with monovalent or polyvalent counterions (cations), for example) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Preferred tackifiers are natural or chemically modified rosins. Rosins are composed predominantly of abietic acid or abietic-acid derivatives.

Further adjuvants that may be added to the PSA are for example antioxidants, fillers, dyes, thickeners, and flow control assistants.

Besides water or other solvents, the PSA is composed in particular to more than 40%, more preferably more than 60%, and very preferably more than 80%, by weight of the PSA polymer, a term which also comprehends mixtures of different PSA polymers (see above).

Key properties of a pressure-sensitive adhesive are the tack (adhesion) and the internal strength (cohesion).

The skilled worker is aware how the particular desired PSA properties can be set. Using crosslinking monomers or external crosslinkers raises the internal strength of the PSA, generally to the detriment of the tack. Self-adhesive articles coated with PSAs of this kind are generally residuelessly redetachable (detachable PSAs). Other PSAs, by virtue of the use of very polar monomers and, if appropriate, relatively large amounts of tackifiers, have a very high tack, and self-adhesive articles furnished with such adhesives are virtually impossible to detach again (permanent PSAs).

In the laminate of the invention it is possible for any desired PSAs to be combined with one another. Both PSA layers may comprise detachable or permanent PSAs. Alternatively it is possible for one of the two PSA layers to comprise a detachable PSA and for the other layer to comprise a permanent PSA.

The thickness of the PSA layers can amount in each case for example to 1 to 500 μm; in particular the thickness is generally at least 3 μm, more preferably at least 5 μm or at least 10 μm; in general the thickness is not greater than 300 μm, more preferably not greater than 200 or 100 μm.

The Carrier Layer

The carrier layer is composed of a composition which comprises a synthetic polymer (carrier polymer for short). Likewise suitable carrier polymers include free-radically polymerized polymers, polyesters or polyadducts. The polymer in question is in particular a polymer obtainable by free-radical addition polymerization, more preferably a polymer obtainable by emulsion polymerization. With very particular preference the carrier polymer is an emulsion polymer.

In particular the carrier polymer is synthesized from free-radically polymerizable compounds (monomers). It is preferably composed of at least 40%, more preferably at least 60%, and very preferably at least 80%, by weight of what are called principal monomers.

The principal monomers are selected from C1-C20 alkyl (meth)acrylates, vinyl esters of carboxylic acids comprising up to 20 C atoms, vinylaromatics having up to 20 C atoms, ethylenically unsaturated nitriles, vinyl halides, vinyl etherss of alcohols comprising 1 to 10 C atoms, aliphatic hydrocarbons having 2 to 8 C atoms and 1 or 2 double bonds, or mixtures of these monomers.

Examples include (meth)acrylic acid alkyl esters with a C1-C10 alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Examples of vinyl esters of carboxylic acids with 1 to 20 C atoms are vinyl laurate, vinyl stearate, vinyl propionate, Versatic acid vinyl esters, and vinyl acetate.

Suitable vinylaromatic compounds include vinyltoluene a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether and vinyl isobutyl ether. Preference is given to vinyl ethers of alcohols comprising 1 to 4 C atoms.

As hydrocarbons having 2 to 8 C atoms and one or two olefinic double bonds mention may be made of butadiene, isoprene and chloroprene, ethylene or propylene. Polymers or copolymers obtained from butadiene or isoprene can also be hydrogenated subsequently.

Preferred principal monomers are the C1 to C10 alkyl (meth)acrylates and vinylaromatics.

Besides the principal monomers it is also possible for the carrier polymer to comprise the further monomers specified above.

The carrier polymer is preferably barely tacky, and preferably is not tacky, at room temperature (21° C.), and is therefore preferably not a pressure-sensitive adhesive. Accordingly a polyester film (polyethylene terephthalate, PET) coated with the composition of the carrier has an adhesion to steel at 21° C. of in particular less than 0.5 N/2.5 cm, more preferably less than 0.2 N/2.5 cm.

The adhesion in this case is determined by the following measurement technique (quickstick value):

The carrier composition is knifecoated at 30 g/m2 (solids) onto sections of PET film 25 mm wide and drying is carried out at 90° C. for 3 minutes.

The quickstick value was determined by clamping both ends of a test strip 17.5 cm long and 2.5 cm wide into the jaws of a tensile machine to form a loop which is then contacted with a chromed steel surface at a rate of 30 cm/min (lowering of the loop onto the chromed steel plate). When contact has been achieved over the full area, a contact time of 1 minute is allowed, after which the loop is removed again, the maximum force measured in the course of the removal, in N/2.5 cm, being defined as the measure of the quickstick value. The measurement is conducted at 20° C. and 50% relative humidity.

The value obtained is a measure of the adhesion and hence of the tack. The carrier composition is therefore preferably barely tacky or with particular preference not tacky.

The glass transition temperature (Tg) of the carrier polymer is preferably greater than −10° C., in particular greater than 0° C., more preferably greater than 20° C.; it is for example −10 to +120° C., more preferably 0 to +100° C., very preferably +20 to +100° C., or +30 to +100° C.; in one very particularly preferred embodiment the glass transition temperature is +40 to +100° C.

The glass transition temperature of the polymer is determined as above.

The carrier composition may be composed of the binder alone (carrier polymer) or else may comprise further additives. Suitable examples include antioxidants, fillers, dyes, thickeners or flow control assistants. In particular the carrier composition is composed of at least 60% more preferably at least 80%, and very preferably at least 90%, by weight of the carrier polymer. The thickness of the carrier layer may in particular amount to 1 to 500 μm; in particular the thickness is generally at least 5 μm, more preferably at least 10 μm, very preferably at least 20 or at least 30 μm; in general the thickness is not greater than 300 μm, with particular preference not greater than 200 or 100 μm.

Preparation of the PSAs and of the Carrier Composition

The corresponding PSA polymers and the carrier polymer can be prepared by typical polymerization methods. With preference not only the PSA polymers but also the carrier polymer are prepared by emulsion polymerization. The PSA polymer and the carrier polymer are therefore preferably in the form of emulsion polymers, i.e., in aqueous polymer dispersion form.

Further constituents of the PSAs and of the carrier composition can be stirred into the aqueous polymer dispersions.

The PSAs and the carrier composition are therefore preferably in aqueous PSA or carrier composition form.

The solids content of the aqueous PSAs and carrier composition is preferably at least 20%, more preferably at least 30%, very preferably at least 40%, by weight, and in general not more than 80%, in particular not more than 75%, or not more than 70%, by weight.

Construction of the Multilayer Laminate Overall

The multilayer laminate may comprise further layers. In particular the PSA layers may be lined with an antistick layer (with the nonstick side, i.e., the detachable side, facing the PSA). The antistick layer is in particular a siliconized paper or a siliconized film. The antistick layer is intended to protect the PSA layer until use. Immediately prior to use, the antistick layer is removed.

Both PSA layers may be lined correspondingly with a detachable antistick layer. If the laminate is to be wound, it is sufficient to line only one side with an antistick layer but that antistick layer ought to have been given a nonstick coating on both sides, i.e., for example, a silicone coating. In the course of winding, the top face of this antistick layer comes into contact with the lower PSA coating and at the same time protects it.

The multilayer laminate (without the redetachable antistick layers) preferably has in total a thickness of 30 μm to 3 mm, more preferably of 50 μm to 500 μm, very preferably of 60 μm to 200 μm.

Production of the Laminate

The multilayer laminate is obtainable in particular by means of a coating method wherein the PSAs and the carrier composition are in aqueous dispersion or solution form (see above) and are coated.

For the method of production, therefore, it is possible with preference to start from the aqueous PSAs and the aqueous carrier composition, as they are defined above, to coat them onto an antistick layer (e.g., siliconized paper or film), and to dry the resulting coating.

In one preferred embodiment the coating of the aqueous PSAs and of the aqueous carrier composition takes place in one method step, i.e., simultaneously.

A coating method suitable for this purpose is known from DE-A-10 2004 007 927, published Sep. 1, 2005. That method uses a multiple cascade die.

The multilayer laminate is accordingly produced preferably by a method in which the at least three fluid, preferably aqueous compositions (two PSAs and a carrier composition) are coated continuously onto a substrate in web form, preferably an antistick layer. Coating here takes place preferably using a multiple cascade die.

The speed of the web-form carrier is preferably 30 to 1500 meters per minute, more preferably 50 to 60, very preferably 80 to 400, meters per minute.

The PSAs and the carrier composition are situated in different stock vessels, and these stock vessels feed a liquid film of the respective PSA and the carrier composition.

A key feature of the multiple cascade die is that an overall film is formed from the individual films to be coated. Within this overall film the individual films are present in the spatial arrangement subsequently desired in the multilayer laminate. The overall film is applied from the multiple cascade die to the moving web-form carrier.

The method in question is preferably a slide coating method. Slide coating methods and, as an alternative thereto, slot coating methods are described for example in Liquid Film Coating, Chapman & Hall, London 1997, Section 11a “Slot coating” and 11b “Slide coating”. Slide coating involves the overall film sliding over a surface, a metal surface for example, and being deposited thereafter on the substrate. In the case of a slot coating method, in contrast, the overall film is applied from a slot or die to the substrate directly, i.e., without sliding.

A further preferred method is a curtain coating method. In curtain coating, a curtain of film in free fall is deposited on the substrate. In order that the film curtain can fall freely, the distance between die or other exit aperture and the moving substrate must be greater than the layer thickness to be coated.

With particular preference the method in question is a slide coating method in combination with a curtain coating method. The cascade die and its position relative to the substrate is reproduced in FIG. 4.1 (slide coating) and FIG. 4.2 (slide coating with curtain coating) of DE-A 10 2004 007 927.

Use

The multilayer laminate is suitable for use as a self-adhesive article, in particular as a double-sided adhesive tape. The invention permits simple production of self-adhesive articles, especially double-sided adhesive tapes. The double-sided adhesive tapes are of simple construction; as the carrier it is also possible to use a synthetic polymer. The self-adhesive articles or adhesive tapes possess tensile strength and have good mechanical properties and good adhesive properties.

### EXAMPLES

Production of a Multilayer Laminate

Composition of the Individual Layers:

PSA 1:

Acronal® V 215, an aqueous dispersion of a carboxyl-containing polyacrylate from BASF for PSAs, solids content 69% by weight, glass transition temperature −43° C.; the dispersion was admixed with 1.0% by weight of wetting agent and 0.2% by weight of thickener, based on the polymer (solids).

PSA 2:

Acronal® A 110 215, an aqueous dispersion of a carboxyl-containing polyacrylate from BASF for PSAs, solids content 55% by weight, glass transition temperature −55° C.; the dispersion was admixed with 1.0% by weight of wetting agent and 0.2% by weight of thickener, based on the polymer (solids).

Carrier Composition

Acronal® S 728, an aqueous dispersion of a styrene-containing polyacrylate from BASF for coating materials, solids content 50% by weight, glass transition temperature 15° C.; the dispersion was admixed with 1.0% by weight of wetting agent and 0.2% by weight of thickener, based on the polymer (solids).

Method of Production:

From the two PSAs and the carrier composition a multilayer laminate was produced in a continuous coating method.

The web-form carrier used was a siliconized polymer film. The speed of the web-form carrier was meters/minute.

The two PSAs and the carrier composition were coated using a multiple cascade die as in DE-A 10 2004 007 927, FIG. 4.2. The method comprises a slide coating method in combination with a curtain coating method. The two PSAs and the carrier composition are stocked in separate vessels; formed to a film in the multiple cascade die; the three films are brought together so that they lie atop one another; and the resulting overall film is coated in unison. The overall film slides within the multiple cascade die first over a metal surface, after which it falls as a curtain onto the carrier web, which is moving forward perpendicularly to the falling curtain.

The coating rates were as follows:
PSA 1 layer: 26.8 g/m2 (dry, corresponding to coat thickness of 26.8 μm)
Carrier composition: 50 g/m2 (dry, corresponding to coat thickness of 50 μm)
PSA 2 layer: 19 g/m2 (dry, corresponding to coat thickness of 19 μm)

The multiple coating obtained is dried continuously, the coated web being passed for this purpose through a drying apparatus. After drying, a further siliconized polyethylene film is deposited on the top PSA layer.

The multilayer laminate obtained has the following construction, the sequence of the layers corresponding to the spatial arrangement:

Siliconized film (is removed prior to use)
PSA 1 layer
Carrier layer
PSA 2 layer

Siliconized film (is removed prior to use)

The multilayer laminate is suitable for use as a double-sided adhesive tape.

The PSA 1 layer is formulated for high adhesion and cohesion. It is suitable for particularly firm, permanent adhesive bonds (peel strength on glass after 1 day of storage at room temperature: 32 N/25 mm, shear strength, measured by adhering a 25×25 mm test strip to glass, and loading the strip with a 1 kg weight, and determining the time taken for the strip to detach: more than 24 hours).

The PSA 2 layer is formulated so that it has a low level of adhesion, and is suitable for redetachable adhesive bonds (peel strength 2.3, shear strength 1.7 hours).

The multilayer laminate has a very good mechanical strength (tensile strength) and is easy to handle.

1. A multilayer laminate comprising at least two pressure-sensitive adhesive layers and a carrier layer located between the pressure-sensitive adhesive layers and comprising a synthetic polymer.

2. The multilayer laminate according to claim 1, wherein the two pressure-sensitive adhesive layers are each composed of a pressure-sensitive adhesive (PSA) which comprises a synthetic polymer as binder, hereinafter referred to as PSA polymer.

3. The multilayer laminate according to claim 1, wherein the PSA polymer is an emulsion polymer.

4. The multilayer laminate according to claim 1, wherein the carrier layer is composed of a carrier composition which comprises an emulsion polymer as binders hereinafter referred to as carrier polymer.

5. The multilayer laminate according to claim 1, wherein the carrier layer is not tacky.

6. The multilayer laminate according to claim 1, wherein the carrier polymer has a glass transition temperature greater than 0° C.

7. The multilayer laminate according to claim 1, wherein the thickness of the pressure-sensitive adhesive layers and of the carrier layer is in each case 1 to 100 μm.

8. The multilayer laminate according to claim 1, comprising a detachable antistick layer on one or both sides.

9. The multilayer laminate according to claim 1, obtainable by a coating method in which the pressure-sensitive adhesive layers and the carrier layer are in aqueous dispersion or solution form.

10. A method of producing a multilayer laminate according to claim 1, which comprises coating out the pressure-sensitive adhesive layers and the carrier layer in aqueous dispersion or solution form and then carrying out drying.

11. The method according to claim 10, wherein the coating of the pressure-sensitive adhesive layers and of the carrier layer takes place simultaneously in one method.

12. The method according to claim 10, wherein the coating of the pressure-sensitive adhesive layers and of the carrier layer takes place using a multiple cascade die.

13. The method according to claim 10, wherein the coating method is a sliding method.

14. The method according to claim 10, wherein the coating method is a curtain coating method.

15. A method of using the multilayer laminate according to claim 1 as a self-adhesive article.

16. A method of using the multilayer laminate according to claim 1 as a double-sided adhesive tape.
